(19) United States
(12) Patent Application Publication
(10) Pub. No.: US 2026/0057859 A1
(43) Pub. Date: Feb. 26, 2026

(54) CONNECTING ROD OF JAZZ DRUM PEDAL

(71) Applicant: K.H.S. MUSICAL INSTRUMENT CO., LTD., New Taipei City (TW)

(72) Inventor: CHIH-CHIEH CHIAO, New Taipei City (TW)

(73) Assignee: K.H.S. MUSICAL INSTRUMENT CO., LTD., New Taipei City (TW)

(21) Appl. No.: 18/814,280

(22) Filed: Aug. 23, 2024

(51) Int. Cl. G10D 13/11; G10D 13/02

(52) U.S. Cl. CPC G10D 13/11; G10D 13/02

(57) ABSTRACT

The present invention provides a connecting rod of a jazz drum pedal, comprising a tube body, an extending rod, a limiting member, and an indicator. The tube body forms an insertion channel along an axial direction, and has a locking hole and an anti-detachment recessed hole for communicating with the insertion channel. The extending rod inserts into the insertion channel along the axial direction, and the limiting member is disposed in the locking hole. The extending rod can be selectively pressed by the limiting member without moving in the insertion channel or released from the limiting member to move freely in the insertion channel. The indicator is inserted into the anti-detachment recessed hole to connect the extending rod, when the extending rod is extended, a portion length of the indicator is kept in the anti-detachment recessed hole, so that an extending length of the extending rod is limited by the indicator within a length from one end to the other end of the anti-detachment recessed hole, and further, the extending rod can be extended within a specific range to prevent the extending rod from detaching from the tube body.

### FIELD OF THE INVENTION

The present invention relates to a connecting rod of a jazz drum pedal, and in particular to an extending rod capable of limiting an extending length of the extending rod during adjustment so that the extending rod will not be separated from the tube body.

### BACKGROUND OF THE INVENTION

In jazz drum playing, double pedaling is a common technique, usually used in situations that require fast and continuous pedaling actions. A double-pedaling pedal usually consists of two pedals and a connecting rod. Each pedal controls a different drumstick to hit a drumhead. In order to allow both the pedals under the left and right feet of a drummer to control the drumsticks to hit the same bass drum, a connecting rod needs to be disposed between the pedals and the drumsticks. In this way, the drummer can operate the two pedals through his/her left and right feet respectively to achieve richer rhythm and timbre changes.

In order to meet the requirements of the distance between the left and right feet of different drummers, an adjustable extending rod is usually provided in the connecting rod, so that a user can change the distance between the two pedals by extending and retracting the extending rod to meet personal comfort and performance requirements. However, most of connecting rod adjustment manners currently on the market only use one limiting member to fix the extending rod, which makes it easy for a user to extend the extending rod too long when adjusting it, causing the extending rod to fall off the connecting rod and thus bring trouble in use for the user.

### SUMMARY OF THE INVENTION

A main objective of the present disclosure is to improve a structural aspect of a connecting rod, so that when a user adjusts a length of a connecting rod, an internal extending rod can be extended and will not be separated from the tube body, and thus the extending length of the extending rod is limited within a fixed length.

A secondary objective of the present disclosure is to allow the user to identify the extending length of the extending rod by setting a scale on a surface of the connecting rod, so that the user can accurately adjust to a target length during each adjustment process.

To achieve the aforementioned objective, the connecting rod of a jazz drum pedal of the present disclosure includes: a tube body, an extending rod, a limiting member, and an indicator.

In this embodiment, the tube body forms an insertion channel along an axial direction. A locking hole and an anti-detachment recessed hole are formed on the tube body for communicating with the insertion channel, and a scale is formed on a surface of the tube body and adjacent to the anti-detachment recessed hole; the extending rod inserts into the insertion channel along the axial direction so that a partial length of the extending rod is positioned in the tube body, and the extending rod has a positioning portion facing the anti-detachment recessed hole; the limiting member is disposed in the locking hole, and the extending rod can be selectively pressed by the limiting member without moving in the insertion channel or released from the limiting member to move freely in the insertion channel; and the indicator inserts into the anti-detachment recessed hole to connect the positioning portion, and a portion length of the indicator overlaps the interior of the anti-detachment recessed hole, so that the indicator can move between a first position located at one end of the anti-detachment recessed hole and a second position located at the other end of the anti-detachment recessed hole.

When the extending rod is extended, the indicator is kept in the anti-detachment recessed hole, so that an extending length of the extending rod is limited to an interval length between the first position and the second position.

Moreover, a section of the insertion channel is set to a polygon, and a section of the extending rod is set to another polygon to match the insertion channel, so that the extending rod cannot rotate relative to the tube body after insertion.

Furthermore, the indicator has a head, a neck and a connecting portion, the head is larger than a width of the anti-detachment recessed hole to prevent the head from inserting into the anti-detachment recessed hole; and the connecting portion and the neck are smaller than the width of the anti-detachment recessed hole to insert into the anti-detachment recessed hole, wherein the indicator has a groove for cooperating with a hand tool, and the groove is capable of being aligned with the scale to display the extending length. Moreover, the indicator has a mark for cooperating with the scale to display the extending length.

In a preferred embodiment, the connecting rod further has an auxiliary extending rod, an auxiliary limiting member and an auxiliary indicator, the tube body has an auxiliary locking hole and an auxiliary anti-detachment recessed hole for communicating with the insertion channel, and an auxiliary scale is formed on a surface of the tube body and adjacent to the auxiliary anti-detachment recessed hole, the auxiliary extending rod inserts into the insertion channel along the axial direction so that a partial length of the auxiliary extending rod is positioned in the tube body, and the extending rod and the auxiliary extending rod are respectively disposed on opposite sides of the tube body, and the auxiliary extending rod has an auxiliary positioning portion facing the auxiliary anti-detachment recessed hole; the auxiliary limiting member is disposed in the auxiliary locking hole, and the auxiliary extending rod can be selectively pressed by the auxiliary limiting member without moving in the insertion channel or released from the auxiliary limiting member to move freely in the insertion channel; the auxiliary indicator inserts into the auxiliary anti-detachment recessed hole to connect the auxiliary positioning portion, and a portion length of the auxiliary indicator overlaps the interior of the auxiliary anti-detachment recessed hole, wherein when the auxiliary extending rod is extended, the auxiliary indicator is kept in the auxiliary anti-detachment recessed hole so that an auxiliary extending length of the auxiliary extending rod is limited by the auxiliary indicator within a length from one end to the other end of the auxiliary anti-detachment recessed hole.

A plurality of tube walls are formed around the tube body, the locking hole and the auxiliary locking hole are opened in one of the tube walls, and the anti-detachment recessed hole and the auxiliary anti-detachment recessed hole are opened in another of tube walls.

The present disclosure is characterized in that the tube body has the anti-detachment recessed hole for communicating with the insertion channel, and the indicator can be fixed to the positioning portion of the extending rod through the anti-detachment recessed hole. At this time, a portion length of the indicator overlaps the interior of the anti-detachment recessed hole. Therefore, when the extending rod is extended along the axial direction, the indicator is kept in the anti-detachment recessed hole, so that the extending length of the extending rod is limited, and the extending rod will not be extended too long to allow the extending rod to be detached from the tube body.

### BRIEF DESCRIPTION OF THE DRAWINGS

FIG. 1 is a schematic diagram of a connecting rod and a jazz drum pedal of the present disclosure in a second preferred embodiment;

FIG. 2 is a schematic diagram of the connecting rod of the present disclosure in a first preferred embodiment;

FIG. 3 is an exploded view of FIG. 2;

FIG. 4A is a schematic diagram of an extending rod extended to a first position in the present disclosure;

FIG. 4B is a schematic diagram of the extending rod extended to a second position in the present disclosure;

FIG. 5 is a schematic diagram of the connecting rod of the present disclosure in the second preferred embodiment; and

FIG. 6 is an exploded view of FIG. 5.

### DETAILED DESCRIPTION OF THE PREFERRED EMBODIMENTS

In order to facilitate a deeper and more detailed recognition and understanding of the construction, use and features of the present disclosure, preferred embodiments are provided and described in detail with reference to the accompanying drawings as follows:

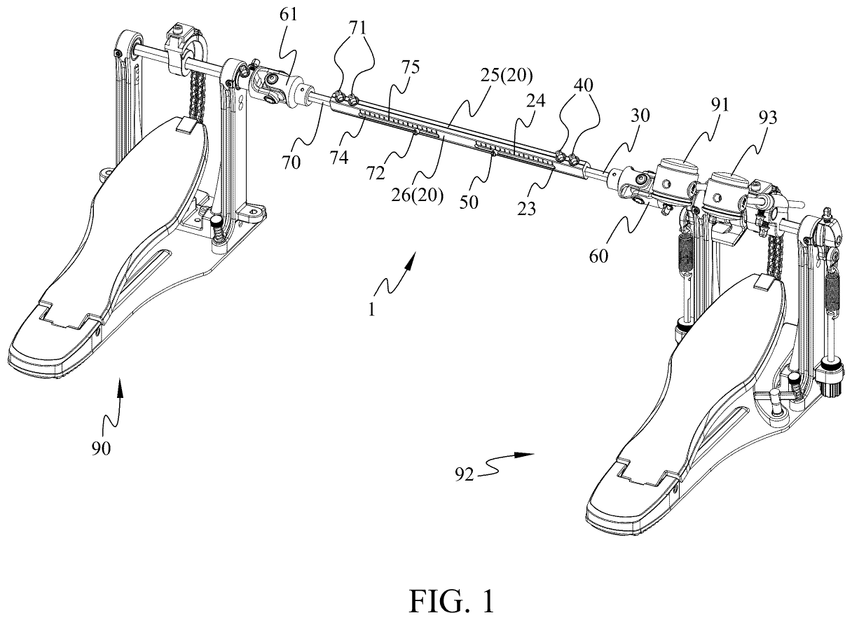

Referring to FIG. 1, a connecting rod 1 of a jazz drum pedal of the present disclosure is mainly connected between a jazz drum slave pedal 90 and a slave drumstick 91. The jazz drum slave pedal 90 can drive the connecting rod 1 to rotate as pedaled by a user, so that the slave drumstick 91 is swung to hit a bass drum (not shown). In this way, the user can respectively set the jazz drum slave pedal 90 and a jazz drum main pedal 92 at the left foot and the right foot, and set the slave drumstick 91 cooperated with the jazz drum slave pedal 90 and a main drumstick 93 cooperated with the jazz drum main pedal 92 on the same bass drum, so that the user can conduct a double-pedaling performance way.

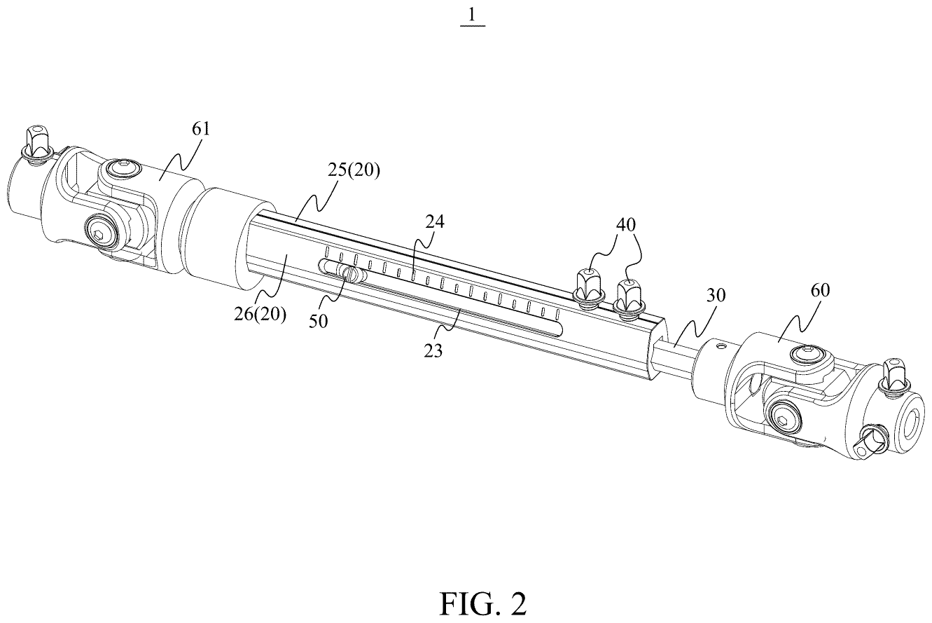

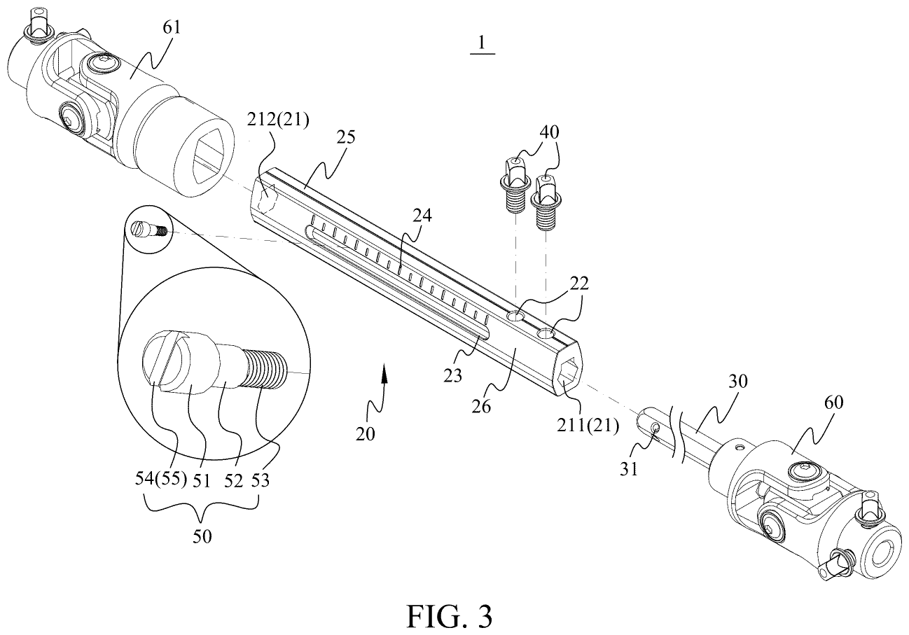

Referring to FIGS. 2 and 3, the connecting rod 1 in a first preferred embodiment includes: a tube body 20, an extending rod 30, a limiting member 40 and an indicator 50. The tube body 20 forms an insertion channel 21 along an axial direction, and the insertion channel 21 has a first insertion port 211 and a second insertion port 212 respectively arranged on two sides of the tube body 20. In the first preferred embodiment, the tube body 20 has an end of the second insertion port 212 connected to a second universal joint 61, the tube body 20 has a locking hole 22 and an anti-detachment recessed hole 23 for communicating with the insertion channel 21, and a scale 24 is formed on a surface of the tube body 20 and adjacent to the anti-detachment recessed hole 23. One end of the extending rod 30 is connected to a first universal joint 60, and the other end of it is inserted into the first insertion port 211 along the axial direction, so that a partial length of the extending rod 30 is inserted into the tube body 20, and the extending rod 30 is provided with a positioning portion 31 facing the anti-detachment recessed hole 23. The limiting member 40 is disposed in the locking hole 22, and the extending rod 30 can be selectively pressed by the limiting member without moving in the insertion channel 21 or released from the limiting member to move freely in the insertion channel 21. The indicator 50 is inserted into the anti-detachment recessed hole 23 to connect the positioning portion 31, and a portion length of the indicator 50 overlaps the interior of the anti-detachment recessed hole 23, so that when the extending rod 30 is extended, a portion length of the indicator 50 is kept in the anti-detachment recessed hole 23, and the extending rod 30 is also kept in the insertion channel 21.

A section of the insertion channel 21 is set to a polygon, and a section of the extending rod 30 is also set to the polygon to match the insertion channel 21, so that the extending rod 30 cannot rotate relative to the tube body 20 after insertion. Moreover, a plurality of tube walls are formed on the outer wall of the tube body 20 to cooperate with the polygon, and the locking hole 22 and the anti-detachment recessed hole 23 are respectively opened in two of the plurality of tube walls. As shown in FIG. 2, when the user uses it, the locking hole 22 is opened in a top face 25 of one of the plurality of tube walls facing upward, so that the user can adjust it conveniently; and the anti-detachment recessed hole 23 is opened in an adjacent face 26 of one of the plurality of tube walls adjacent to the top face 25, so that the user can identify the indicator 50, the anti-detachment recessed hole 23 and the scale 24 by lowering his/her head.

Referring to FIG. 3 again, the indicator 50 further has a head 51, a neck 52 and a connecting portion 53. The head 51 is larger than a width of the anti-detachment recessed hole 23. The connecting portion 53 and the neck 52 are smaller than the width of the anti-detachment recessed hole 23, so that the indicator 50 can be inserted from the anti-detachment recessed hole 23 and positioned at the positioning portion 31 of the extending rod 30, and the neck 52 can be accommodated in the anti-detachment recessed hole 23, while the head 51 is exposed from the anti-detachment recessed hole 23. Moreover, the indicator 50 further has a groove 54 that can be used in cooperation with a hand tool and an alignment indicator 55 that can cooperate with the scale 24 to display the extending length. In the first preferred embodiment, the groove 54 also has the function of the alignment indicator 55, and the user can use the groove 54 in cooperation with the scale 24 to display the extending length.

The indicator 50 is not limited to the implementation aspect of the first preferred embodiment. The indicator 50 can also consist of only the neck 52 and the connecting portion 53, and the groove 54 and the alignment indicator 55 are disposed on the neck 52; and the connecting portion 53 and the positioning portion 31 are also not limited to being connected in a screw joint manner. It only needs that after the indicator 50 is installed, the alignment indicator 55 can cooperate with the scale 24 to display the extending length.

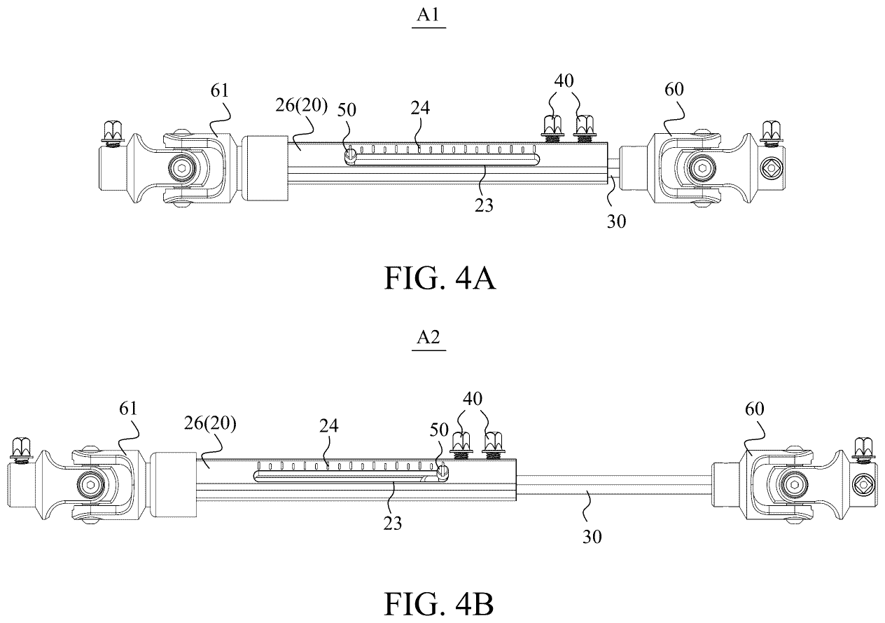

Referring to FIGS. 4A and 4B, in the first preferred embodiment, when the extending rod 30 is shortened inwardly to the shortest, the indicator is abutted against a first position A1 at the innermost side of the anti-detachment recessed hole 23, and the groove 54 will point to a minimum value in the scale 24; and when the extending rod 30 is extended outwardly, the user only needs to separate the limiting member 40 from the extending rod 30, then the extending rod 30 can move freely in the insertion channel 21, and when the extending rod 30 is extended outward until an interval length at which the indicator 50 is abutted against a second position A2 on the outermost side of the anti-detachment recessed hole 23, the groove 54 will point to a maximum value in the scale 24, so that the extending length of the extending rod 30 will be limited to an interval length between the first position A1 and the second position A2.

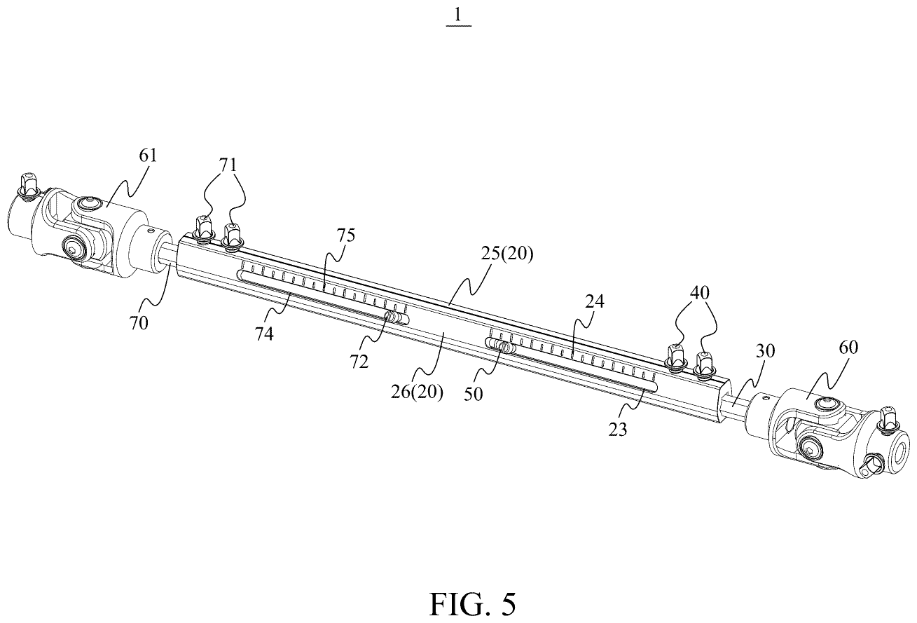

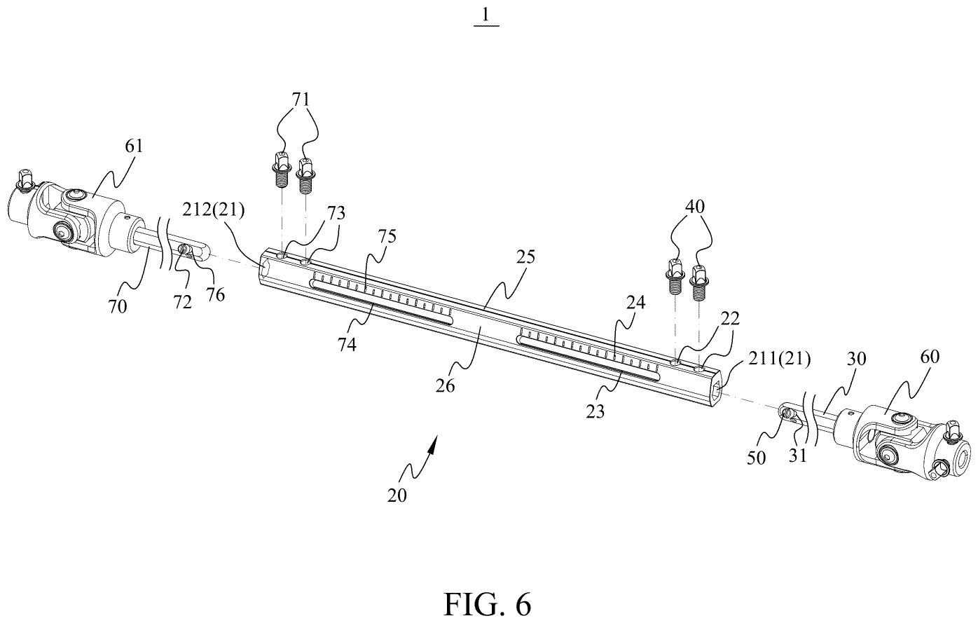

Referring to FIGS. 5 and 6, in the second preferred embodiment, the difference from the first preferred embodiment is only that the tube body 20 can accommodate an auxiliary extending rod 70, and the remaining structures are the same as those of the first preferred embodiment and thus are not described anymore. The connecting rod 1 further includes the auxiliary extending rod 70, an auxiliary limiting member 71 and an auxiliary indicator 72. The tube body 20 has an auxiliary locking hole 73 and an auxiliary anti-detachment recessed hole 74 for communicating with the insertion channel 21, and an auxiliary scale 75 is formed on a surface of the tube body 20 and adjacent to the auxiliary anti-detachment recessed hole 74.

One end of the auxiliary extending rod 70 is connected to the second universal joint 61 and the other end of it is inserted into the second insertion port 212 along the axial direction, so that a partial length of the auxiliary extending rod 70 is inserted into the tube body 20, and the auxiliary extending rod 70 is provided with an auxiliary positioning portion 76 facing the auxiliary anti-detachment recessed hole 74. The auxiliary limiting member 71 is disposed in the auxiliary locking hole 73, and the auxiliary extending rod 70 can be selectively pressed by the auxiliary limiting member without moving in the insertion channel 21 or released from the auxiliary limiting member to move freely in the insertion channel 21.

The auxiliary indicator 72 is inserted into the auxiliary anti-detachment recessed hole 74 to connect the auxiliary positioning portion 76, and a portion length of the auxiliary indicator 72 overlaps the interior of the auxiliary anti-detachment recessed hole 74. When the auxiliary extending rod 70 is extended, the auxiliary indicator 72 is kept in the auxiliary anti-detachment recessed hole 74, so that an auxiliary extending length of the auxiliary extending rod 70 is limited by the auxiliary indicator 72 within a length from one end to the other end of the auxiliary anti-detachment recessed hole 74.

Moreover, the locking hole 22 and the auxiliary locking hole 73 are jointly opened on the top face 25 of the plurality of tube walls, and the anti-detachment recessed hole 23 and the auxiliary anti-detachment recessed hole 74 are jointly opened on the adjacent face 26 of the plurality of tube walls.

In summary of the above, in the present disclosure, the indicator 50 that can cooperate with the anti-detachment recessed hole 23 is set on the extending rod 30, so that when the user adjusts the length of the extending rod 30, the extending rod 30 will not be extended too long and thus detached from the tube body 20, and the indicator 50 can also cooperate with the scale 24 to display the extending length.

What is claimed is:

1. A connecting rod of a jazz drum pedal, comprising:
A tube body forming an insertion channel along an axial direction. a locking hole and an anti-detachment recessed hole are formed on the tube body for communicating with the insertion channel, and a scale is formed on a surface of the tube body and adjacent to the anti-detachment recessed hole;
an extending rod inserts into the insertion channel along the axial direction so that a partial length of the extending rod is positioned in the tube body, and the extending rod has a positioning portion facing the anti-detachment recessed hole;
a limiting member being disposed in the locking hole, the extending rod can be selectively pressed by the limiting member without moving in the insertion channel or released from the limiting member to move freely in the insertion channel; and
an indicator inserts into the anti-detachment recessed hole to connect to the positioning portion, and a portion length of the indicator overlaps an interior of the anti-detachment recessed hole so that the indicator can move between a first position located at one end of the anti-detachment recessed hole and a second position located at the other end of the anti-detachment recessed hole;
wherein when the extending rod is extended, the indicator is kept in the anti-detachment recessed hole, so that an extending length of the extending rod is limited to an interval length between the first position and the second position.

2. The connecting rod of a jazz drum pedal as claimed in claim 1, wherein a section of the insertion channel is set to a polygon, and a section of the extending rod is set to another polygon to match the insertion channel, so that the extending rod cannot rotate relative to the tube body after insertion.

3. The connecting rod of a jazz drum pedal as claimed in claim 1, wherein the indicator has a head, a neck and a connecting portion, the head is larger than a width of the anti-detachment recessed hole to prevent the head from inserting into the anti-detachment recessed hole; and the connecting portion and the neck are smaller than the width of the anti-detachment recessed hole to insert into the anti-detachment recessed hole.

4. The connecting rod of a jazz drum pedal as claimed in claim 1, wherein the indicator has a groove for cooperating with a hand tool, and the groove is capable of being aligned with the scale to display the extending length.

5. The connecting rod of a jazz drum pedal as claimed in claim 1, wherein the indicator has a mark for cooperating with the scale to display the extending length.

6. The connecting rod of a jazz drum pedal as claimed in claim 1, wherein the connecting rod further has an auxiliary extending rod, an auxiliary limiting member and an auxiliary indicator, the tube body has an auxiliary locking hole and an auxiliary anti-detachment recessed hole for communicating with the insertion channel, and an auxiliary scale is formed on a surface of the tube body and adjacent to the auxiliary anti-detachment recessed hole, the auxiliary extending rod inserts into the insertion channel along the axial direction so that a partial length of the auxiliary extending rod is positioned in the tube body, and the extending rod and the auxiliary extending rod are respectively disposed on opposite sides of the tube body, and the auxiliary extending rod has an auxiliary positioning portion facing the auxiliary anti-detachment recessed hole; the auxiliary limiting member is disposed in the auxiliary locking hole, and the auxiliary extending rod can be selectively pressed by the auxiliary limiting member without moving in the insertion channel or released from the auxiliary limiting member to move freely in the insertion channel; the auxiliary indicator inserts into the auxiliary anti-detachment recessed hole to connect the auxiliary positioning portion, and a portion length of the auxiliary indicator overlaps the interior of the auxiliary anti-detachment recessed hole, wherein when the auxiliary extending rod is extended, the auxiliary indicator is kept in the auxiliary anti-detachment recessed hole so that an auxiliary extending length of the auxiliary extending rod is limited by the auxiliary indicator within a length from one end to the other end of the auxiliary anti-detachment recessed hole.

7. The connecting rod of a jazz drum pedal as claimed in claim 6, wherein a plurality of tube walls are formed around the tube body, the locking hole and the auxiliary locking hole are opened in one of the tube walls, and the anti-detachment recessed hole and the auxiliary anti-detachment recessed hole are opened in another of tube walls.
